(19) United States
(12) Patent Application Publication
(10) Pub. No.: US 2025/0355243 A1
(43) Pub. Date: Nov. 20, 2025

(54) Apparatus and Methods for Enhanced Simulation of Light Propagation in a Scattering Medium

(71) Applicant: Regents of the Univ of Colorado, a body corporate, Denver, CO (US)

(72) Inventors: Thariq Shanavas, Boulder, CO (US); Juliet Gopinath, Boulder, CO (US); Robert McLeod, Boulder, CO (US); Mark Siemens, Denver, CO (US)

(73) Assignee: Regents of the Univ of Colorado, a body corporate, Denver, CO (US)

(21) Appl. No.: 19/210,929

(22) Filed: May 16, 2025

Related U.S. Application Data
(60) Provisional application No. 63/648,891, filed on May 17, 2024.

(51) Int. Cl. G02B 27/00; G06F 30/23

(52) U.S. Cl. CPC G02B 27/0012; G06F 30/23

(57) ABSTRACT

Apparatus and methods for modeling an optical system in order to predict the behavior of tightly focused light in a turbulent medium. A model of an optical device in the system and a model of the index of refraction in a sample are provided. Then the electric fields just before and at the turbulent medium are determined. Next the system propagates the electric field into the medium by small steps using a finite difference version of a wave equation for two most recent fields, starting with the fields before and at the sample. Propagation is continued until a desired area is reached.

### BACKGROUND OF THE INVENTION

This invention was made with government support under grant number DBI 1919541 awarded by the National Science Foundation. The government has certain rights in the invention. U.S. Pat. App. No. 63/648,891 filed 17 May 2024, is incorporated herein by reference.

### FIELD OF THE INVENTION

The present invention relates to apparatus and methods for improved simulation of light propagation in a scattering medium.

### DISCUSSION OF RELATED ART

Optical scattering poses a significant challenge to high-resolution microscopy within turbulent media such as deep tissue. In optical microscopy, the spatial resolution of images acquired through scanning techniques is inherently limited by the size of the instrument's point spread function (PSF). The degradation of the PSF due to scattering hence limits the maximum imaging depth and resolution of a microscope in deep tissue. Calculating the PSF of microscopes in deep tissue under high-NA (>0.6) objectives is a scenario that strains existing methods.

For instance, Beam Propagation Method (BPM) employs the paraxial approximation for projecting the properties of the medium into a plane and is therefore not suitable for high-NA objective lenses. Angular Spectrum Method (ASM) cannot be applied to inhomogeneous media without making a paraxial approximation, limiting their use with high-NA objectives. Finite Difference Time Domain (FDTD), Finite Difference Frequency Domain (FDFD) and Finite Element Method (FEM) are non-paraxial and compatible with inhomogeneous media, but they require prohibitively large memory and simulation time for imaging depths exceeding tens of microns. Finally, ray tracing techniques like Monte Carlo methods fail to reproduce statistical properties of speckles produced by tissue, and therefore cannot be expected to give accurate results.

### SUMMARY OF THE INVENTION

The present invention relates to apparatus and methods for modeling optical systems and predicting the behavior of tightly focused light in turbulent or scattering mediums. A novel finite difference solver is used for the wave equation. By leveraging a ‘weak backscattering’ approximation, the proposed solver bypasses the slow iterative step in conventional finite difference methods, significantly reducing the computational complexity. Consequently, the solver uses about one tenth as much memory as FDTD or FDFD for imaging depths up to 80 μm, and the relative advantage widens with more depth. Some embodiments are applicable for objectives with NA above 0.3.

To accurately predict the performance of various microscopy techniques in thick samples, a model efficiently solves Maxwell's equation in highly scattering media. It simulates the deterioration of a laser beam wavefront without making a paraxial approximation, enabling accurate modeling of high-numerical-aperture (NA) objective lenses commonly employed in experiments.

### BRIEF DESCRIPTION OF THE DRAWINGS

FIG. 1 is a schematic block diagram of an optical system for focusing light in a scattering medium.

FIG. 2 is a block diagram of a system for modeling the optical system and predicting the behavior of tightly focused light in a turbulent medium.

FIG. 3 is a flow diagram showing a process of modeling the optical system and predicting the behavior of tightly focused light in a turbulent medium.

FIG. 4 is a side view schematic diagram of the sample showing where steps of the process are performed within the sample.

FIG. 5 is a schematic diagram of apparatus for testing the system of FIGS. 1-3.

FIG. 6 is a plot showing performance of the system.

### DETAILED DESCRIPTION OF THE INVENTION

The system described below is applicable to a broad range of scanning microscopy and localization techniques including confocal microscopy, stimulated emission depletion microscopy (STED), MINFLUX and ground state depletion microscopy. Notably, the method can utilize readily obtainable macroscopic tissue parameters. As a practical demonstration, we investigated the performance of Laguerre-Gaussian versus Hermite-Gaussian depletion beams in STED microscopy.

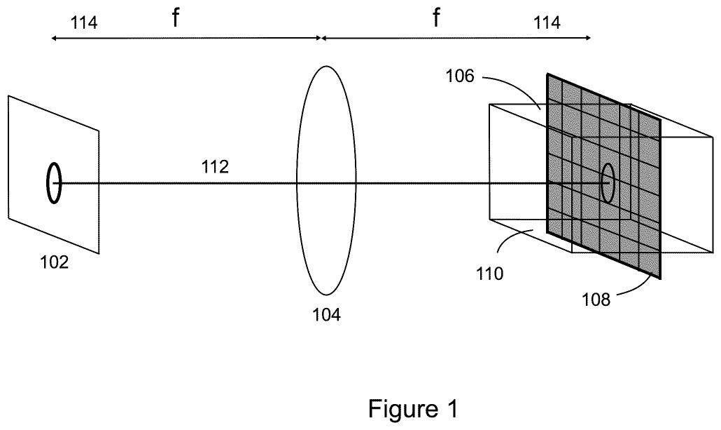

FIG. 1 is a schematic block diagram of an optical system 100 for focusing light in a turbulent/scattering medium 106. In this example, source beam 102 is placed 1 focal length (f) away from the optical element 104 (such as a microscope objective). The scattering sample 106 is placed such that the desired focal plane 108 within the medium 106 is 1 focal length from the optical element 104. Thus the scattering sample 106 front surface 110 is closer than 1 focal length away, and the image of source beam 102 focuses at focal plane 108 within sample 106. A refractive index matching medium (not shown) may be used between the optical element and the scattering sample to minimize Fresnel reflections at the tissue surface 110.

Within sample 106, the refractive index varies spatially, because of the inhomogeneities inherent in turbulent specimens. Models of various scattering mediums are available or can be developed.

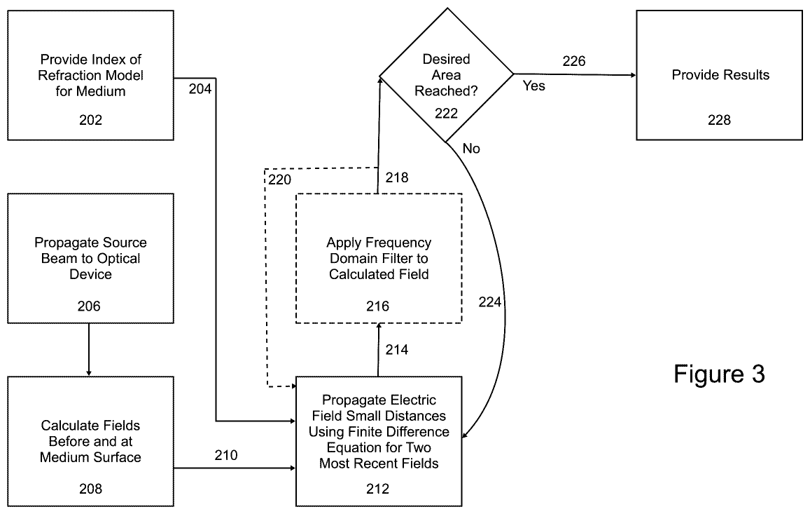

The field at the surface 110 of sample 106 is calculated analytically, for example, using the Debye-Wolf integral, and propagated to the focal plane 108 using a finite difference solver, as shown in FIG. 3.

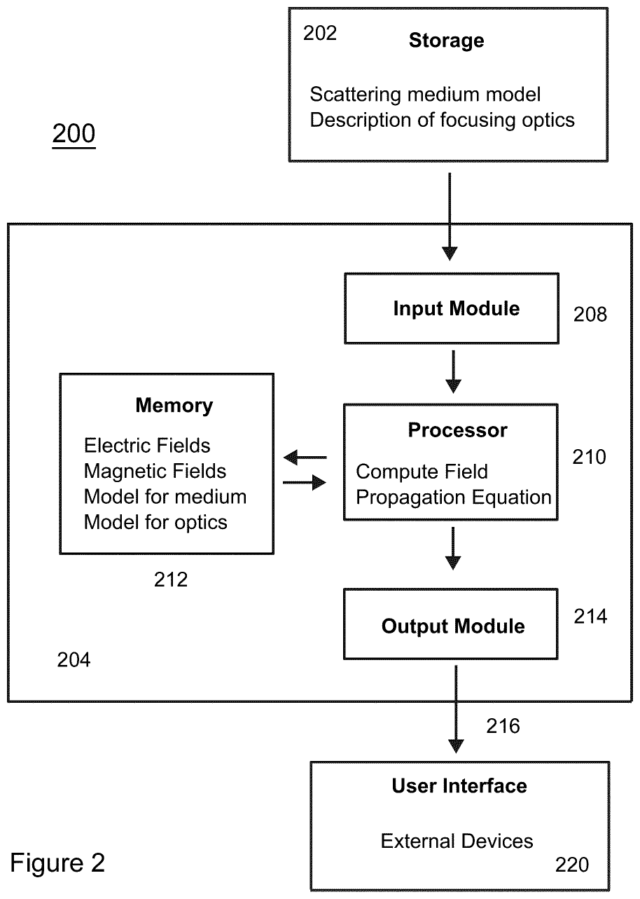

FIG. 2 is a block diagram of a system 200 for modeling the optical system and predicting the behavior of tightly focused light in a turbulent medium. In this particular example, a model of the scattering medium 106 and a model of optical device 104 have been previously calculated and are stored in a storage device 202. These are provided to input module 208 which provides inputs to a processor 210 within processing system 204. As an alternative, either the scattering medium model or the optical element model or both may be calculated by processing system 204.

These models are stored in memory 212 of processing system 204 for use by processor 210.

Processor 210 in this example calculates electrical fields resulting from light source 102 at various points in the system. See FIG. 3 for details of these calculations. Fields just before and at front surface 110 may be provided to processing system 204 from storage or may be calculated by processor 210. Processor 210 computationally propagates the field into medium 106 in small steps as shown in FIG. 3. The field is propagated into medium 106 until it reaches a desired area. At last this final propagated field is provided to output module 214, which provides output to an external device 220 such as a display or database for further processing.

The present system is computationally efficient compared to other finite difference techniques. In an experiment it took about 150 MB RAM and took 20 seconds on an Apple M1 processor to calculate the beam profile at a 10 μm imaging depth. The memory 212 requirement scales with depth d as O(d²) and the computation time scales as O(d^{2.37}). In contrast, the memory requirement and computation time for the FDTD, FDFD, and FEM scale as O(d³). For example, it is estimated that multiple terabytes of memory would be necessary to simulate the beam profile at 85 μm with the FEM in COMSOL, whereas the present method uses around 5 GB.

FIG. 3 is a flow diagram showing an example of the process of utilizing a fast finite difference solver to improve high-resolution microscopy simulation within turbulent medium 106 such as biological tissue. In this example, the process is divided into two basic stages. The first stage, comprising steps 206 and 208 analytically calculates electric fields 210 just before and at the tissue surface 110 generated by a tightly focused beam 102. Step 202 provides a model 204 of medium 106.

The second stage is based on inputs 204 and 210 and employs a finite difference solver to numerically propagate the fields from the tissue surface 110 to a desired area (such as focal plane 108) within sample 106.

In step 202, a model 204 of refractive index fluctuation within the sample is generated or provided based on known qualities of sample 106.

In step 206, source beam 102 is propagated to optical element 104, in this example using Angular Spectrum Method (ASM). In step 208, the field just before surface 110 and the field at surface 110 are both calculated, in this example using a Debye-Wolf integral. These two fields constitute the inputs 210 to the finite difference solver step 212. The finite difference equation in this example is derived from Maxwell's wave equation with or without a term for polarization mixing, i.e.,

$${∇}^{2} \vec{E} + 2 ∇ [ \vec{E} \cdot ∇ ( ln ( n ) ) ] - \frac{{n}^{2}}{{c}^{2}} \frac{{\partial }^{2} \vec{E}}{\partial {t}^{2}} = 0$$

The term \vec{E}.∇(ln(n)) introduces polarization mixing between x, y and z field polarizations, but this term may be omitted to reduce computational complexity at the cost of lower simulation accuracy. The polarization mixing term is included in the following examples.

The finite difference equation used in this example is:

$${E}_{x} ( i , j , k + 2 ) = 2 {E}_{x} ( i , j , k + 1 ) - {E}_{x} ( i , j , k ) - Δ {z}^{2} ( \frac{{\partial }^{2} {E}_{x}}{\partial {x}^{2}} + \frac{{\partial }^{2} {E}_{x}}{\partial {y}^{2}} + 2 \frac{\partial }{\partial x} [ \vec{E} \cdot ∇ ( ln ( n ) ) ] + {( \frac{n ( i , j , k + 1 ) ω}{c} )}^{2} {E}_{x} ( i , j , k + 1 ) ) \qquad ( 2 )$$

While the finite difference equation for the field in the x-direction Eₓ(i, j, k) is shown, the finite difference equation for fields in the y or z direction can be obtained by exchanging Eₓ(i, j, k) for E_{y}(i, j, k) or E_{z}(i, j, k) respectively.

In step 212, the electrical field is propagated a small distance (Δz) using the finite difference equation.

To see what happens in the first step, set k=1 in the equation above resulting in the following equation.

$${E}_{x} ( i , j , 3 ) = 2 {E}_{x} ( i , j , 2 ) - {E}_{x} ( i , j , 1 ) - Δ {z}^{2} ( \frac{{\partial }^{2} {E}_{x}}{\partial {x}^{2}} + \frac{{\partial }^{2} {E}_{x}}{\partial {y}^{2}} + 2 \frac{\partial }{\partial x} [ \vec{E} \cdot ∇ ( ln ( n ) ) ] + {( \frac{n ( i , j , 2 ) ω}{c} )}^{2} {E}_{x} ( i , j , 2 ) ) \qquad Equation 1$$

The first two fields are inputs 210 to step 212. Thereafter, the inputs to step 212 are the two most recently calculated fields by step 112, here with application of a frequency domain filter in step 216 to provide numerical stability to the propagation step.

The newly calculated field 214 is provided to a frequency domain filter, which filters the new field (and optionally returns the filtered value 220 to propagation step 212). See equation 2. Decision step 222 uses the results 218 of step 216 to determine whether the new field is at the focal plane 108 of sample 106. If it is 226, the process ends and the results are provided to the user in step 228, for example on a display.

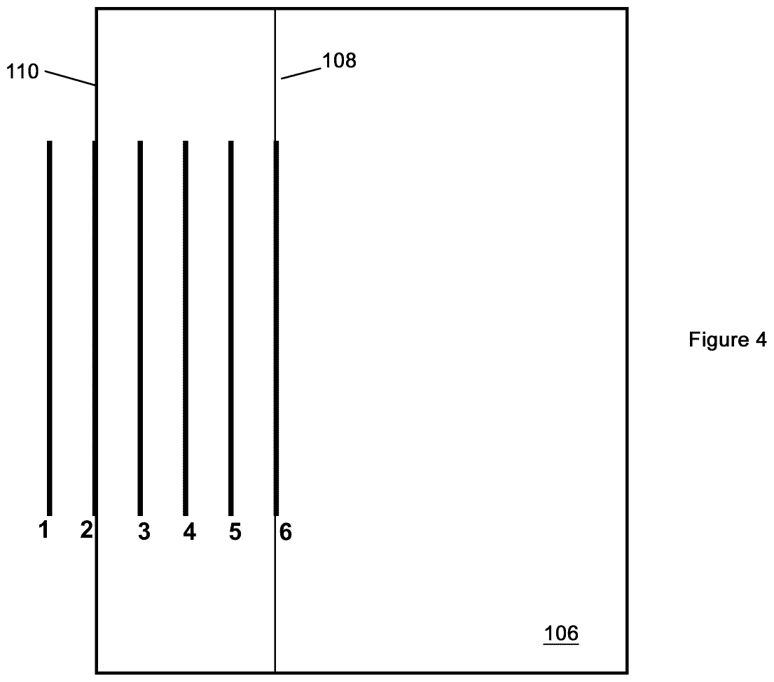

Refer to FIG. 4 to identify the particular planes in the following description.

Eₓ(i, j, 1) and Eₓ(i, j, 2) are calculated in this example by the Debye-Wolf integral. The gradient term ∇(ln(n)) is evaluated as a finite difference using n(i, j, 1) and n(i, j, 2).

n(i, j, 1) refers to the refractive index between planes 1 and 2 in FIG. 3, n (i, j, 2) refers to the refractive index between planes 2 and 3 in FIG. 3, etc. Please note that since n(i, j, 1) is outside the tissue surface, it is just a constant value. n(i, j, 2), n(i, j, 3), etc. have strong fluctuations that resemble biological tissue. These are generated using the model from step 202.

These fluctuations are generated using the macroscopically measured anisotropy factor, mean refractive index, and scattering mean free path. Using a finite difference solver, the fields at the surface of the tissue calculated in the previous step are propagated to the focal plane in steps. The finite difference equation is derived from a vectorial time-dependent wave equation that includes a polarization-mixing term for inhomogeneous media.

In step 216, the frequency domain filter applied after each time the finite difference equation is used to stabilize the FDS against numerical instability. One explicit example of the application of the filter for the Eₓ(i, j, 3) field is provided. After Eₓ(i, j, 3) is calculated using the equation above, the frequency domain filter [symbol] is applied as shown below.

$$ℋ = \{ \begin{matrix}1 & if \sqrt{{f}_{x}^{2} + {f}_{y}^{2}} < \frac{n}{λ} \\ {e}^{- 2 πΔ z \sqrt{( {f}_{x}^{2} + {f}_{y}^{2} ) - {( \frac{n}{λ} )}^{2}}} & if \sqrt{{f}_{x}^{2} + {f}_{y}^{2}} > \frac{n}{λ}\end{matrix}$$

where Δz is the step size of the finite difference solver in the direction of propagation, which in this example is the positive z-axis, and n is the average index of refraction of the scattering medium and A is the wavelength of light. [symbol] is applied in the frequency domain. Therefore, the electric field Eₓ is first converted to frequency-space via a Fourier transform. i.e.,

$${E}_{x} ( i , j , 3 ) = {ℱ}^{- 1} ( ℋ . ℱ ( {E}_{x} ( i , j , 3 ) ) )$$

where [symbol] is the Fourier Transform and [symbol] is the inverse Fourier Transform.

The value of Eₓ(i, j, 3) calculated in the previous step is overwritten with the new filtered value. We then use this filtered value of Eₓ(i, j, 3) for the next step of the FDS to calculate Eₓ(i, j, 4). If the newest field has not yet reached focal plane 108, process returns 224 to step 212, and the latest two fields are used to calculate a new field a small distance further into sample 106. In this example only the most recent two fields are used in step 212, which reduces memory requirements. So Eₓ(i, j, 1) and Eₓ(i, j, 2) are used to calculate Eₓ(i, j, 3), Eₓ(i, j, 2) and Eₓ(i, j, 3) are used to calculate Eₓ(i, j, 4), etc.

FIG. 4 illustrates this process. Field 1, Eₓ(i, j, 1), is a small distance before sample 106 front surface 110 and field 2, Eₓ(i, j, 2), is at surface 110. These two fields are then used to propagate field 3, Eₓ(i, j, 3), by a distance Az within sample 106. In this simplified example, field 6, Eₓ(i, j, 6), is at focal plane 108, so decision step 222 determines that the process is complete.

Step 222 determines whether the field has been propagated to focal plane 108. If it has not, process returns through path 224 to step 212, and the field is propagated another small amount and step 212 is repeated with the newly calculated field. If it has, process continues through path 226 to end the simulation and provide results in step 228.

The same process is applied to calculate the fields in the y and z direction if desired, i.e., E_{y} and E_{z} at the focal plane.

The finite difference solver was validated by reproducing the experimental data on resolution of deep tissue microscopy and excellent agreement was found. As an example of how this technique can be used to test new microscopy protocols, the present inventors compared the performance of recently proposed Hermite-Gaussian (HG) beams to conventional Laguerre-Gaussian (LG) beams for stimulated emission depletion (STED) microscopy in deep tissue. Results show that tightly focused LG and HG beams have similar propagation characteristics in scattering media.

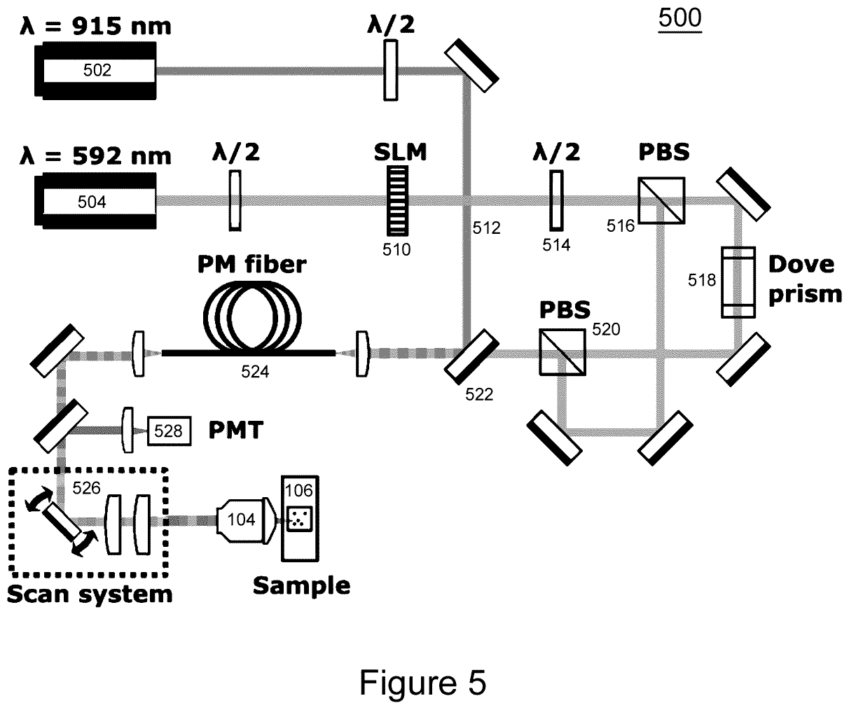

FIG. 5 shows the set up used to test the process. A custom built laser scanning microscope system was used for the experiment. The excitation and depletion lasers were delivered to the microscope via a PM fiber. For the 2P excitation source, a homebuilt modelocked Ti:Sapphire laser 502 centered at 915 nm was used. The pulsed depletion laser 504 was chosen to overlap with the redshifted end of the green fluorescent protein emission spectrum with a wavelength of 592 nm (NKT Katana HP-06 A 60x) and was triggered by the excitation laser.

To shape the depletion beam into a donut, a spatial light modulator 510 was used to make a HG mode which may be coupled into higher order modes of the PM fiber. The HG beam 512 passes through a half wave plate 514 and polarizing beam splitter 516 to separate the light into two arms. One arm is rotated 90 degrees by a Dove prism 518, so that when the two arms are recombined by polarizing beam splitter 520, there are two orthogonal HG modes which are coupled into fiber 524, creating the donut shape needed for STED imaging. Beam splitter 522 recombined the excitation and depletion beams.

A MEMS mirror (Mirrorcle A7B2.1-3600AL-TINY20.4-A/TP) system 526 raster scanned the spatially and temporally overlapped excitation and depletion beams. A standard scan and tube lens enabled a telecentric imaging system 104 into sample 106. The experiment used a 60x, 1.3 NA silicone immersion oil objective to more closely match the index of tissue. At the greatest sample depths, excitation and depletion powers of up to 8.3 and 59 mW respectively were used, at the back aperture of the objective. Fluorescence was collected back through the objective 104, tube and scan lenses and descanned before being focused onto a photomultiplier tube 528 (Hamamatsu H7422P40) and photon counting unit (Hamamatsu C9744).

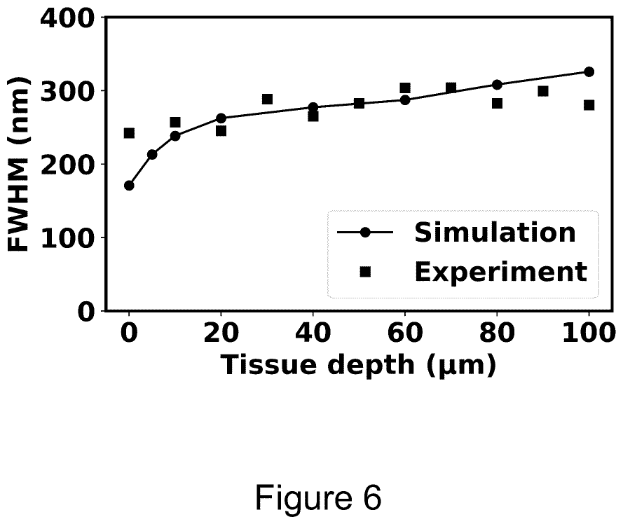

FIG. 6 is a plot showing performance of the system. FIG. 6 shows full-width-half-maximum (FWHM) of the STED PSF as a function of imaging depth. Simulated FWHM using LG and incoherent donut beams are shown (circular symbols), along with experimental results using an LG beam as a benchmark (square symbols). The imaging depth is adjusted by translating the focusing optic without changing the focal length.

While the exemplary preferred embodiments of the present invention are described herein with particularity, those skilled in the art will appreciate various changes, additions, and applications other than those specifically mentioned, which are within the spirit of this invention. Those skilled in the art will appreciate that it may be useful to provide multiple propagated fields for analysis rather than just the last field. Or the system may propagate into the medium using more than just the two more recent fields (e.g. the most recent three field. While determining electrical fields in planes is discussed, this also includes, for example, determining fields at points or multiple points. The two initial fields may both be before the front surface of the medium or both be inside the medium. A Plane refers to any space that is described using two coordinates and does not necessarily refer to just flat surfaces. Embodiments of this invention may determine or calculate fields on discrete points that lie on a plane rather than continuously on all locations in a plane.

What is claimed is:

1. The process of modeling an optical system for predicting the behavior of tightly focused light in a turbulent medium comprising the steps of:
providing a model of an optical device within the system;
providing a model of refractive index within the turbulent medium;
determining electric fields at multiple non-coincident planes or discrete points that lie on planes just before, at, or inside the turbulent medium;
propagating the electric field by a small increment to a plane inside the medium using previously determined or propagated fields via a finite difference equation;
determining whether a desired area within the turbulent medium has been reached by the propagation step;
if the desired area has not been reached by the propagation step, propagating fields deeper in the medium using previously determined or propagated fields;
terminating propagation when the desired area has been reached; and
once propagation terminates, providing a resulting electric field.

2. The process of claim 1 wherein the non-coincident planes are a plane just before a front surface of the turbulent medium and a plane at the front surface of the turbulent medium.

3. The process of claim 1 wherein the propagating step uses the two most recent determined or propagated fields.

4. The process of claim 1 wherein the step of providing a resulting electric field provides multiple determined fields.

5. The process of claim 1 wherein the desired area is a focal plane of the optical device.

6. The process of claim 1 further including the step of providing numerical stability to the propagation step.

7. The process of claim 1 wherein the step of providing numerical stability includes the step of applying a frequency domain filter to electric fields.

8. The process of claim 1 wherein the step of determining electric fields calculates the electric fields.

9. The process of claim 8 wherein the step of determining electric fields just before and at the turbulent medium utilizes a Debye-Wolf integral.

10. The process of claim 1 wherein the step of providing a model of an optical device within the system includes the step of calculating the model.

11. The process of claim 1 wherein the step of providing a model of an optical device utilizes a stored model.

12. The process of claim 1 wherein the propagating step discards portions of the model of the optical device not being used in the propagating step.

13. The process of claim 1 wherein the process models light emanating from a source, models an optical device that tightly focuses light and performs other useful manipulations, and models the desired area within the turbulent medium a focal length past the modelled optical device.

14. The process of claim 1 wherein the finite difference equation is the second-order form of the Maxwell's wave equation.

15. Apparatus for modeling an optical system for predicting the behavior of tightly focused light in a turbulent medium comprising:
a source of a model of an optical device within the optical system;
a source of a model of refractive index within the turbulent medium;
a processor configured to—
determine electric fields just before and at the turbulent medium,
propagate the electric field into the medium by a small amount using a finite difference version of a wave equation for two most recent fields, starting with the determined fields,
determine whether a desired area within the turbulent medium has been reached by the propagation step, and
providing propagated electric field at the desired area.

16. The apparatus of claim 15 wherein the source of the model of the optical device is a storage element.

17. The apparatus of claim 15 wherein the source of the model of refractive index within the turbulent element is a storage element.

18. The apparatus of claim 15 wherein the source of the electric fields just before and at the turbulent medium is a storage element.

19. The apparatus of claim 15 wherein the processor calculates the electric fields just before and at the turbulent medium using a Debye-Wolf integral.
